(19) United States
(12) Patent Application Publication
(10) Pub. No.: US 2008/0175396 A1
(43) Pub. Date: Jul. 24, 2008

(54) Apparatus and method of out-of-head localization of sound image output from headpones

(75) Inventors: Sang-chul Ko, Seoul (KR); Young-tae Kim, Seongnam-si (KR); Sang-wook Kim, Seoul (KR); Jung-ho Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/889,412

(22) Filed: Aug. 13, 2007

(30) Foreign Application Priority Data
Jan. 23, 2007 (KR) 10-2007-0007235

(51) Int. Cl. H04R 5/00

(52) U.S. Cl. 381/17

(57) ABSTRACT

An apparatus for and method of externalizing a sound image output to headphones are provided. The method of externalizing a sound image output to headphones includes: localizing the sound image of an input signal to a predetermined area in front of a listener; and signal-processing a left signal component and a right signal component of the input signal with different delay values and gain values, respectively. According to the method and apparatus, the sound image output to the headphones can be localized to a virtual sound stage in front of the listener, thereby reducing tiredness occurring when listening through headphones, and even when a sound source includes many monophonic component, the sound image can be externalized.

### CROSS-REFERENCE TO RELATED PATENT APPLICATIONS

This application claims the benefit of Korean Patent Application No. 10-2007-0007235, filed on Jan. 23, 2007, in the Korean Intellectual Property Office, the disclosure of which is incorporated herein in its entirety by reference.

### BACKGROUND OF THE INVENTION

1. Field of the Invention

The present invention relates to an apparatus for and method of externalizing a sound image output to a mobile phones, and more particularly, to an apparatus for and method of providing a natural listening environment similar to an ordinary stereo sound environment, by removing in-head localization occurring in an earphones and/or mobile phone environment.

2. Description of the Related Art

Audio signal reproduction apparatuses include apparatuses, such as speakers, which do not require direct physical contact, and apparatuses, such as headphones, earphones, and wireless headsets, which are worn over the ears of a listener. Unlike speakers, in the reproduction apparatuses which are worn over the ears of a listener, such as the headphones, an unnatural phenomenon occurs in which a sound image is formed at the center of the head of the listener according to changes in the wearing state of the headphones, in addition to the quality characteristic of the headphones. This phenomenon is referred to as ‘in-head localization’. Accordingly, in a headphone listening environment, a method of making sounds heard outside the head as in an ordinary stereo sound environment is required. Like this, making a sound image output from the headphones positioned outside the head, thereby making the sound image more natural, is referred to as externalization of a sound image. A variety of methods have been used as the sound image externalization.

A first method is using a reflection sound and reverberation effect, thereby making a sound image generated inside the head, heard from a surrounding space. A second method is using a sound image localization method, thereby localizing the sound source generated inside the head, to a virtual position close to the listener. However, though the first method can send a sound image outside the head of the listener, the method cannot provide a stable sound image to the listener. That is, according to the first method, sound images are generated above the head or at the back of the head of the listener, and the generated sound images are not stable but continuously changing. Due to this phenomenon, if the listener uses the headphones for a long time, the listener feels tiredness and the sound color changes.

According to the second method, and the sound image localization, a sound image fixed to the inside of the head can be localized in a predetermined direction and a part of the sound image can be externalized. However, according to the second method, when only one sound image exists and the sound image is clear, the method works effectively, but when a sound image is not clear or appears symmetrically, externalization of a sound image does not work effectively.

### SUMMARY OF THE INVENTION

The present invention provides an apparatus and method by which a sound image is localized to a predetermined area in a headphone listening environment, thereby reducing tiredness, and even when a sound source includes many monophonic components, the sound image can be externalized.

The present invention also provides a computer readable recording medium having embodied thereon a computer program for executing the method in a computer.

The technical objects of the present invention are not limited to these, and other technical objects not described here can be clearly understood by a person skilled in the art of the present invention from the following description of the present invention.

According to an aspect of the present invention, there is provided an apparatus for externalizing a sound image output from headphones, including: a front recognition unit localizing the sound image of an input signal to a predetermined area in front of a listener; and a space recognition unit signal-processing a left signal component and a right signal component of the input signal with different delay values and gain values, respectively.

According to another aspect of the present invention, there is provided a method of externalizing a sound image output to headphones including: localizing the sound image of an input signal to a predetermined area in front of a listener; and signal-processing a left signal component and a right signal component of the input signal with different delay values and gain values, respectively.

According to still another aspect of the present invention, there is provided a computer readable recording medium having embodied thereon a computer program for executing the method of externalizing a sound image output from headphones.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating an apparatus for externalizing a sound image output from headphones according to an embodiment of the present invention;

FIG. 2 is a schematic diagram illustrating the concept of a virtual sound stage used in an embodiment of the present invention;

FIG. 3 is a detailed diagram illustrating a structure of a front recognition unit illustrated in FIG. 1 according to an embodiment of the present invention;

FIG. 4 is a detailed diagram illustrating a structure of a space recognition unit illustrated in FIG. 1 according to an embodiment of the present invention;

FIG. 5A is a diagram illustrating sound source paths through which an early reflection sound is transferred to a listener when the listener is at the center of a symmetric space according to an embodiment of the present invention;

FIG. 5B is a diagram illustrating sound source paths through which an early reflection sound is transferred to a listener when the listener is at the center of an asymmetric space according to an embodiment of the present invention;

FIG. 6 is a schematic diagram illustrating a structure of an early reflection sound processing unit illustrated in FIG. 4 according to an embodiment of the present invention;

FIG. 7 is a detailed diagram illustrating a structure of the early reflection sound processing unit illustrated in FIG. 4 according to an embodiment of the present invention;

FIG. 8 is a detailed diagram illustrating a structure of a late reverberation sound processing unit illustrated in FIG. 4 according to an embodiment of the present invention;

FIG. 9 is a diagram illustrating a structure of an all-pass filter illustrated in FIG. 8 according to an embodiment of the present invention;

FIG. 10 is a flowchart illustrating a method of externalizing a sound image output from headphones according to an embodiment of the present invention;

FIG. 11 is a flowchart illustrating a process of localizing a sound image of an input signal to a virtual sound stage in front of a listener according to an embodiment of the present invention; and

FIG. 12 is a detailed diagram of a process of providing a space effect to a listener according to an embodiment of the present invention.

### DETAILED DESCRIPTION OF THE INVENTION

The present invention will now be described more fully with reference to the accompanying drawings, in which exemplary embodiments of the invention are shown.

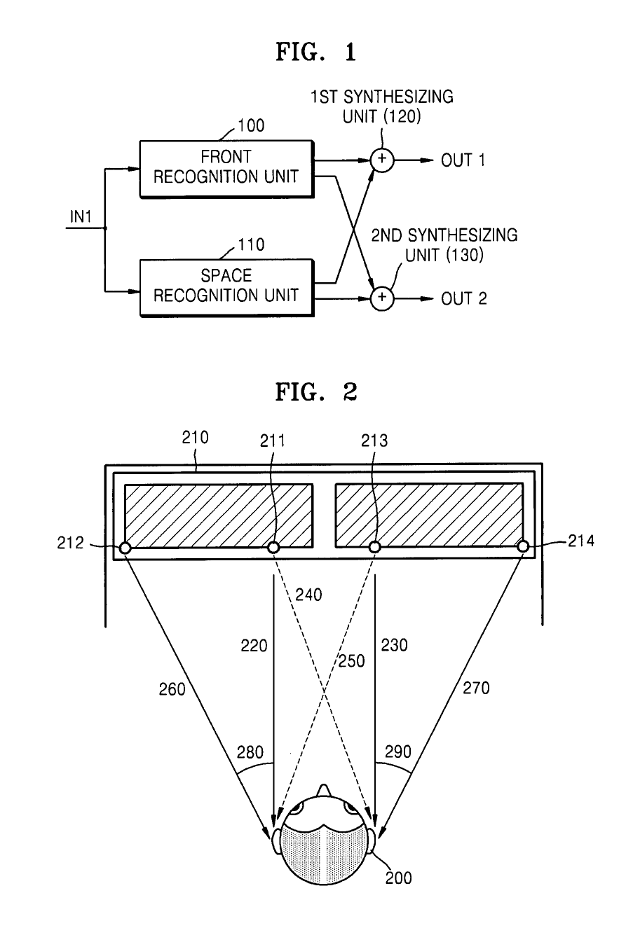

FIG. 1 is a diagram illustrating an apparatus for externalizing a sound image output from headphones according to an embodiment of the present invention.

The apparatus for externalizing a sound image according to the current embodiment includes a front recognition unit 100 and a space recognition unit 110.

The front recognition unit 100 localizes a sound image of an input signal input through an input terminal IN 1, to a predetermined area in front of a listener. In this case, the input signal input through the input terminal IN 1 includes a left signal component and a right signal component.

The space recognition unit 110 sets a delay value and gain value of the left signal component and a delay value and gain value of the right signal component of the input signal input through the input terminal IN 1, differently, and with the differently set delay values and gain values, signal-processes the left signal component and right signal component, respectively, of the input signal. Through this signal-processing, a space effect is provided to the listener and a sound image output to the headphones is localized to the outside of the head of the listener.

FIG. 2 is a schematic diagram illustrating the concept of a ‘virtual sound stage’ used in an embodiment of the present invention.

Generally, in order to make a listener listen to a stable sound source, it is good to make a reference sound image of the sound source be always positioned in a predetermined direction. If the reference sound image moves, the listener continuously tries to find the position of the sound image, and this gives the listener confusion or tiredness. Accordingly, in an embodiment of the present invention, a new concept, a ‘virtual sound stage’, is introduced. That is, in the embodiment of the present invention, as illustrated in FIG. 2, it is assumed that a virtual sound stage 210 exists in a place distant from in front of a listener 200, and a reference sound image is localized to the virtual sound stage 210 sufficiently distant from in front of the listener 200. That is, in the current embodiment, a sound image output to headphones is localized to the virtual sound stage 210 through the front recognition unit 100 illustrated in FIG. 1. In this case, as illustrated in FIG. 2, paths for a sound source transferred to the listener 200 from the virtual sound stage 210 can be roughly broken down into those of direct sounds 220, 230, 240, and 250 transferred from in front of the listener 200 and those of reflection sounds 260 and 270 transferred to the listener 200 after diffracted or reflected from the sides of the virtual sound stage 210. Accordingly, the sound image output from the headphones can be localized to the positions 211, 212, 213, and 214 where the direct sounds 220, 230, 240, and 250, and the reflection sounds 260 and 270 are generated, respectively, thereby expressing the direct sounds 220, 230, 240, and 250 and the reflection sounds 260 and 270 transferred to the listener 200.

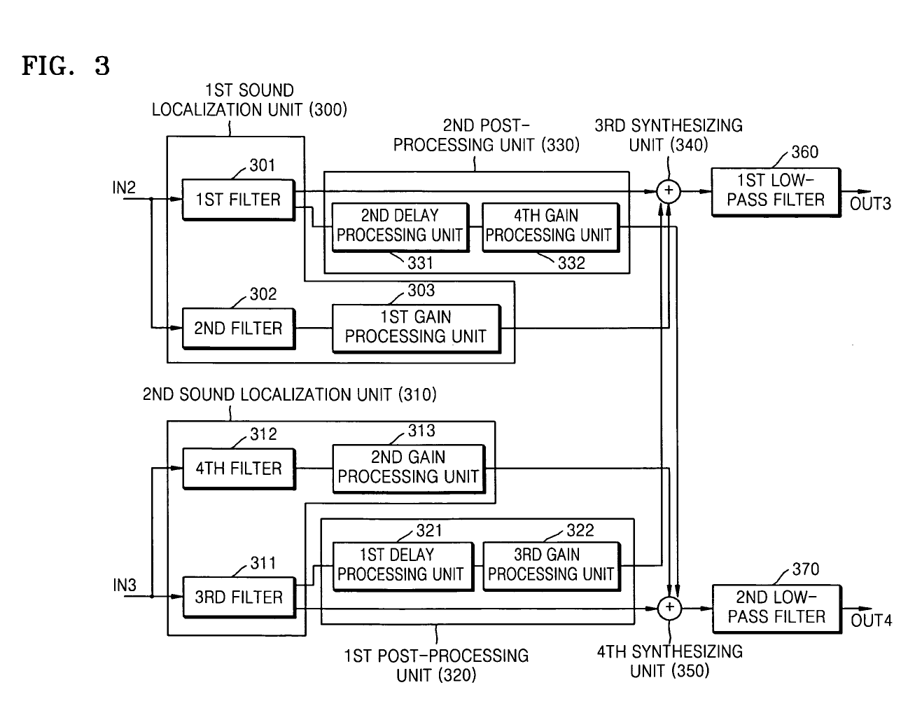

FIG. 3 is a detailed diagram illustrating a structure of a front recognition unit illustrated in FIG. 1 according to an embodiment of the present invention.

A process performed in the front recognition unit 100 illustrated in FIG. 1 will be explained in detail with reference to FIGS. 2 and 3.

The front recognition unit 100 is composed of a first sound image localization unit 300, a second sound image localization unit 310, a first post-processing unit 320, a second post-processing unit 330, a third synthesizing unit 340, a fourth synthesizing unit 350, a first low-pass filter 360, and a second low-pass filter 370.

The first sound image localization unit 300 receives the input of a left signal component through an input terminal IN 2, and localizes a sound image of the input left signal component to the left area of the virtual sound stage 210. The left signal component whose sound image is localized to the left area includes the direct sound 220 transferred from the virtual sound stage 210 to the front of the listener 200, and the reflection sound 260 transferred from the edge of the left area of the virtual sound stage 210 to the listener 200.

The first sound image localization unit 300 includes a first filter 301, a second filter 302, and a first gain processing unit 303.

The first filter 301 localizes the direct sound 200 transferred to the front of the left ear of the listener 200 in the left signal component input through the input terminal IN 2, to the first position 211 corresponding to a direction perpendicular to the left ear of the listener 200. That is, the first filter 301 is used to express the direct sound 220 transferred from the first position 211 of the virtual sound stage 210 to the left ear of the listener 200, as illustrated in FIG. 2. As the first filter 301, a head related transfer function measured at the first position 211 is used. Since the head related transfer function can accurately express the frequency characteristic in a sound source direction as well as a sound source path, it can minimize a phenomenon that the quality of sound becomes unnatural when an algorithm is implemented.

The second filter 302 and the first gain processing unit 303 localize a sound image of the reflection sound 260 transferred to the left ear of the listener 200 in the left signal component input through the input terminal IN 2, to the second position 212 corresponding to the edge of the left area of the virtual sound stage 210. As the second filter 302, a head related transfer function measured at the second position 212 is used. Since a reflection sound is reflected by another object unlike a direct sound directly transferred from a sound source, the magnitude of the reflection sound is relatively smaller than that of the direct sound. Accordingly, in order to implement a reflection sound, the first gain processing unit 303 for adjusting the magnitude should be disposed.

In this way, if the left signal component is input through the input terminal IN 2, the input left signal component is filtered through the second filter 302, and the gain of the filtered signal is adjusted through the first gain processing unit 303, then, the sound image of the reflection sound 260 transferred to the left ear in the left signal component can be localized to the second position 212. In this case, the gain value adjusted by the first gain processing unit 303 can be determined by using the angle between the direct sound 220 and the reflection sound 260 of the left signal component.

The second sound image localization unit 310 receives the input of a right signal component through an input terminal IN 3, and localizes a sound image of the input right signal component to the right area of the virtual sound stage 210. The right signal component whose sound image is localized to the right area includes the direct sound 230 transferred from the virtual sound stage 210 to the front of the listener 200, and the reflection sound 270 transferred from the edge of the right area of the virtual sound stage 210 to the listener 200.

The second sound image localization unit 310 includes a third filter 311, a fourth filter 312, a second gain processing unit 313.

The third filter 311 localizes the direct sound 230 transferred to the right ear of the listener 200 in the right signal component input through the input terminal IN 3, to the third position 213 corresponding to a direction perpendicular to the right ear of the listener 200. That is, the third filter 311 is used to express the direct sound 230 transferred from the third position 213 of the virtual sound stage 210 to the right ear of the listener 200 as illustrated in FIG. 2. As the third filter 311, a head related transfer function measured at the third position 213 is used. Though the first position 211 and the third position 213 are expressed as positions different from each other in the current embodiment, the farther the virtual sound stage 210 is positioned from the front of the listener 200, the closer the interval between the first position 211 and the third position 213 becomes. Accordingly, the first position 211 and the third position 213 may be expressed as an identical position.

The fourth filter 312 and the second gain processing unit 313 localize a sound image of the reflection sound 270 transferred to the right ear of the listener 200 in the right signal component input through the input terminal IN 3, to the fourth position 214 corresponding to the edge of the right area of the virtual sound stage 210. As the fourth filter 312, a head related function measured at the fourth position 214 is used. Since a reflection sound is reflected by another object unlike a direct sound directly transferred from a sound source, the magnitude of the reflection sound is relatively smaller than that of the direct sound. Accordingly, in order to implement a reflection sound, the second gain processing unit 313 for adjusting the magnitude should be disposed.

In this way, if the right signal component is input through the input terminal IN 3, the input right signal component is filtered through the fourth filter 312, and the gain of the filtered signal is adjusted through the second gain processing unit 313, then, the sound image of the reflection sound 270 transferred to the right ear in the right signal component can be localized to the fourth position 214. In this case, the gain value adjusted by the second gain processing unit 313 can be determined by using the angle between the direct sound 230 and the reflection sound 270 of the right signal component.

The first post-processing unit 320 receives the input of the right signal component filtered by the third filter 311, and localizes a sound image of the input right signal component to the right area of the virtual sound stage 210. In direct sounds directly transferred from the virtual sound stage 210 to the listener 200, in addition to the transfer of the direct sounds 220 and 230 to the corresponding ears, the direct sound 220 of the left signal component and the direct sound 230 of the right signal component may also be transferred to the opposite ears, respectively. Accordingly, the first post-processing unit 320 for localizing a sound image of the direct sound 250 transferred to the left ear of the listener 200 in the right signal component, to the right area of the virtual sound stage 210 is necessary. Compensating of a direct sound transferred to the opposite ear in this way is referred to as cross-feed.

The first post-processing unit 320 includes a first delay processing unit 321 and a third gain processing unit 322.

The first delay processing unit 321 receives the input of the right signal component filtered through the third filter 311, delays the input right signal component for a time corresponding to a delay value set by the first delay processing unit 321, and outputs the delayed signal component.

The third gain processing unit 322 receives the input of the signal delayed through the first delay processing unit 322, adjusts the gain of the input signal, and localizes a sound image of the direct sound 250 transferred to the left ear in the right signal component, to the third position 213 of the virtual sound stage 210. That is, through the first post-processing unit 320, while the sound image localized signal is transferred to the left ear of the listener 200, the signal is localized to the third position 213 of the right area of the virtual sound stage 210.

The second post-processing unit 330 receives the input of the left signal component filtered by the first filter 301. In direct sounds directly transferred from the virtual sound stage 210 to the listener 200, in addition to the transfer of the direct sounds 220 and 230 to the corresponding ears, the direct sound 220 of the left signal component and the direct sound 230 of the right signal component may also be transferred to the opposite ears, respectively. Accordingly, the second post-processing unit 330 for localizing a sound image of the direct sound 240 transferred to the right ear of the listener 200 in the left signal component, to the left area of the virtual sound stage 210 is necessary. Compensating of a direct sound transferred to the opposite ear in this way is referred to as cross-feed.

The second post-processing unit 330 includes a second delay processing unit 331 and a fourth gain processing unit 332.

The second delay processing unit 331 receives the input of the left signal component filtered through the first filter 301, delays the input left signal component for a time corresponding to a delay value set by the second delay processing unit 331, and outputs the delayed signal component.

The fourth gain processing unit 332 receives the input of the signal delayed through the second delay processing unit 331, adjusts the gain of the input signal, and localizes a sound image of the direct sound 240 transferred to the right ear in the left signal component, to the first position 211 of the virtual sound stage 210. That is, through the second post-processing unit 330, while the sound image localized signal is transferred to the right ear of the listener 200, the signal is localized to the first position 211 of the left area of the virtual sound stage 210. The sounds 240 and 250 each transferred to the ear on the opposite side have delayed times and smaller magnitudes compared to the sounds 220 and 230 each transferred to the ear on the same side. Accordingly, in order to localize the sound images, the delay processing units 321 and 331 and the gain processing units 322 and 332 are necessary.

The third synthesizing unit 340 receives the inputs of the signals sound image localized through the first sound localization unit 300 and the first post-processing unit 320, and synthesizes all the input signals.

The fourth synthesizing unit 350 receives the inputs of the signals sound image localized through the second sound image localization unit 310 and the second post-processing unit 330, and synthesizes all the input signals.

The first low-pass filter 360 filters the signal synthesized through the first synthesizing unit 340, and applies the filtered low frequency signal to the left headphone, thereby outputting the signal to an output terminal OUT 3.

The second low-pass filter 350 filters the signal synthesized through the second synthesizing unit 350, and applies the filtered low frequency signal to the right headphone, thereby outputting the signal to an output terminal OUT 4.

In this case, the reason why only the low frequency signals are filtered through the first low-pass filter 360 and the second low-pass filter 370 is to remove high frequency distortion.

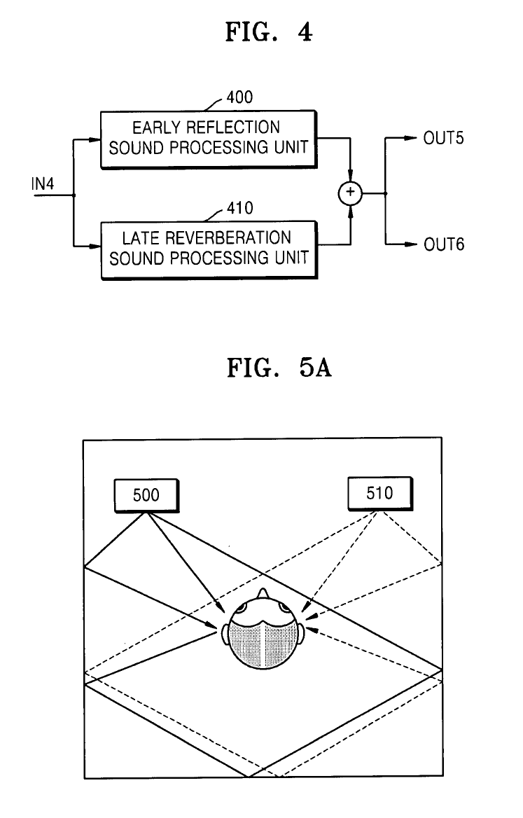

FIG. 4 is a detailed diagram illustrating a structure of a space recognition unit illustrated in FIG. 1 according to an embodiment of the present invention.

A process performed in the space recognition unit 110 illustrated in FIG. 1 will now be explained in detail with reference to FIG. 4.

The space recognition unit 110 according to the current embodiment includes an early reflection sound processing unit 400 and a late reverberation sound processing unit 410.

The early reflection sound processing unit 400 designs a listening space to be asymmetric, in order for a signal input through the input terminal IN 4 to be asymmetrically reflected in the listening space. If the listening space is designed to be symmetric in all directions, a phenomenon in which when a sound source is heard, the sound quality is distorted because a spatial acoustic characteristic is amplified with respect to a listening position can occur. Meanwhile, if the listening space is asymmetric, reflection occurs asymmetrically, and thus the characteristic of a sound field space is evenly distributed irrespective of a listening position. Accordingly, in an embodiment of the present invention, a new concept, “dissymmetric reflection’, is introduced and an early reflection sound is processed to be reflected dissymmetrically.

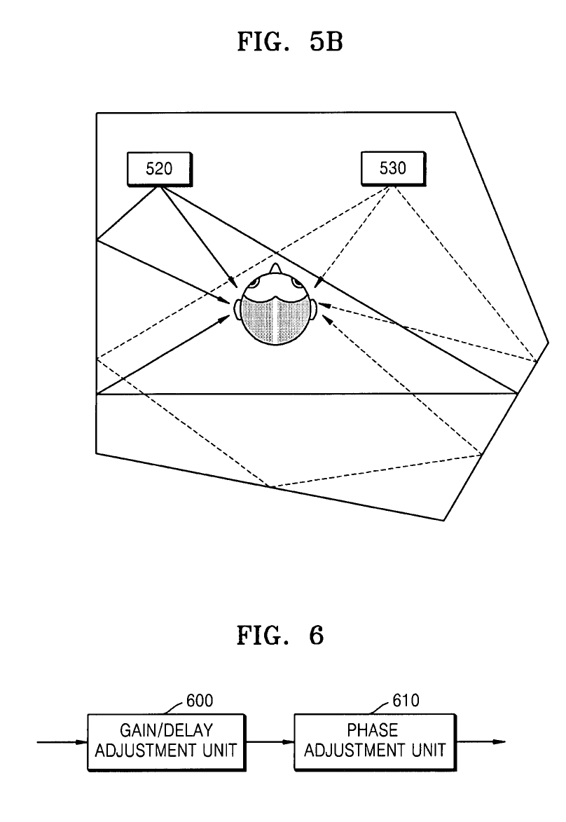

FIG. 5A is a diagram illustrating sound source paths through which an early reflection sound is transferred to a listener when the listener is at the center of a symmetric space according to an embodiment of the present invention.

As illustrated in FIG. 5A, if the listening space of the listener is designed to be symmetric in all directions and an identical sound field effect is applied to a left channel 500 and a right channel 510, reflection sounds in the same direction with identical magnitudes are transferred to the left and right ears of the listener. Accordingly, depending on a sound source, a phenomenon in which the sound source is formed inside the head and which is opposite to a spatial effect may occur. This phenomenon occurs more strongly when an identical signal is generated as a sound source in both the left and right channels like a monophonic signal.

FIG. 5B is a diagram illustrating sound source paths through which an early reflection sound is transferred to a listener when the listener is at the center of a dissymmetric space according to an embodiment of the present invention.

As illustrated in FIG. 5B, if the listening space of the listener is designed to be dissymmetric, even when an identical sound field effect is applied to a left channel 520 and a right channel 530, the magnitudes and directions of reflection sounds transferred to the left and/or right ears of the listener are different from each other, and therefore the listener can always feel a spatial effect. That is, even when a sound source is generated as identical signals in the left and right channels like a monophonic signal, the magnitudes and directions of reflection sounds are set to be different from each other, and therefore the listener can feel a spatial effect. Accordingly, the early reflection sound processing unit 400 illustrated in FIG. 4 according to the current embodiment performs a process by which an early reflection sound is reflected dissymmetrically, as illustrated in FIG. 5B.

FIG. 6 is a schematic diagram illustrating a structure of the early reflection sound processing unit 400 illustrated in FIG. 4 according to an embodiment of the present invention.

The early reflection sound processing unit 400 illustrated in FIG. 4 according to the current embodiment includes a gain/delay adjustment unit 600 and a phase adjustment unit 610. The early reflection sound processing unit 400 processes a signal so that an early reflection sound becomes dissymmetric in relation to a listening space. For this, the early reflection sound processing unit 400 includes the gain/delay adjustment unit 600 and the phase adjustment unit 610, and through the gain/delay adjustment unit 600 and the phase adjustment unit 610, the early reflection sound processing unit 400 adjusts the gain values, delay values, and phase values of the left and right channels.

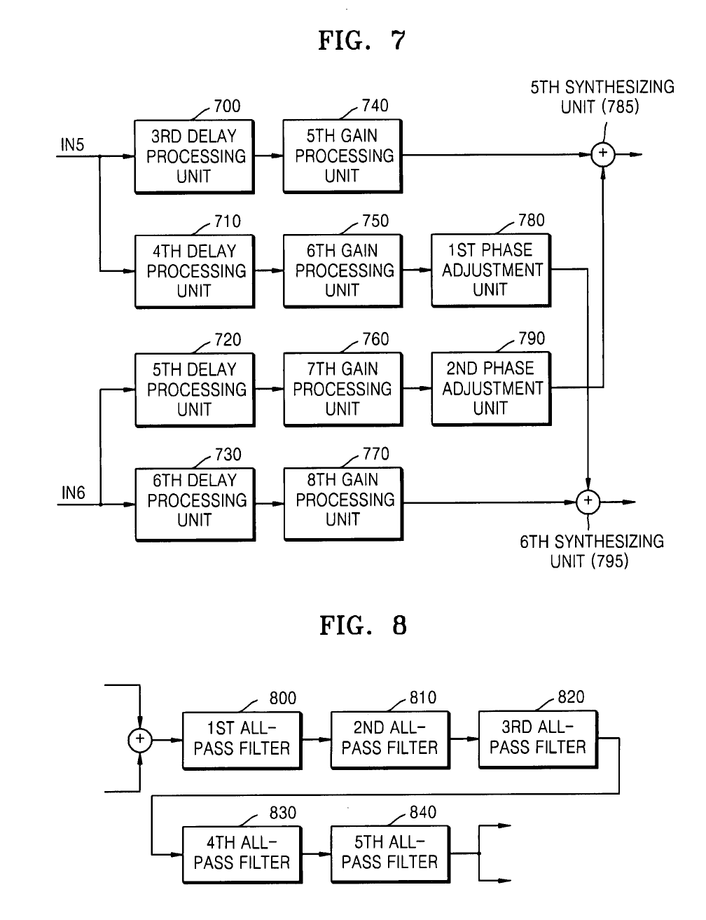

FIG. 7 is a detailed diagram illustrating a structure of the early reflection sound processing unit 400 illustrated in FIG. 4 according to an embodiment of the present invention.

A process performed in the early reflection sound processing unit 400 illustrated in FIG. 4 will now be explained in detail with reference to FIG. 7.

The early reflection sound processing unit 400 includes four delay processing units 700, 710, 720, and 730, four gain processing units 740, 750, 760, and 770, and two phase processing units 780 and 790. Though the early reflection sound processing unit 400 is formed with the four delay processing units 700, 710, 720, and 730, the four gain processing units 740, 750, 760, and 770, and the two phase processing units 780 and 790 in the current embodiment, the present invention is not limited to this and the numbers of delay processing units, gain processing units, and phase processing units can be adjusted to different ones.

If a left signal component is input through an input terminal IN 5, the third delay processing unit 700 delays the input left signal component according to a set delay value. The fifth gain processing unit 740 receives the input of the left signal component delayed in the delay processing unit 700, adjusts the gain of the signal and outputs the signal.

If a right signal component is input through an input terminal IN 6, the input right signal component is delayed and gain-adjusted through the sixth delay processing unit 730 and the eighth gain processing unit 770, and then, is output. In this case, the delay value and gain value of the left signal component are set to be different from the delay value and gain value, respectively, of the right signal component, thereby providing a dissymmetric effect. However, the spatial effect of a signal is mostly affected by a low frequency component equal to or lower than 1 KHz, and it is not easy to provide a dissymmetric effect to a low frequency component only with different delay values and gain values. Accordingly, the early reflection sound processing unit 400 illustrated in FIG. 4 according to the current embodiment includes phase adjustment units 780 and 790. Through the phase adjustment units 780 and 790, the phases are adjusted so that the early reflection sounds of the left signal component and the right signal component can be dissymmetric. In this way, the dissymmetric effect of a low frequency can be increased through the phase adjustment units 780 and 790.

The fifth synthesizing unit 785 receives the inputs of the left signal component, which is delayed and gain-adjusted through the third delay processing unit 700 and the fifth gain processing unit 740, and the right signal component, which is delayed and gain- and phase-adjusted through a fifth delay processing unit 720, a seventh gain processing unit 760, and the second phase adjustment unit 790. The fifth synthesizing unit 785 synthesizes the input left signal component and right signal component, and applies the synthesized signal to the left headphone, thereby outputting the signal.

The sixth synthesizing unit 795 receives the inputs of the right signal component, which is delayed and gain-adjusted through the sixth delay processing unit 730 and the eighth gain processing unit 770, and the left signal component, which is delayed and gain- and phase-adjusted through a fourth delay processing unit 710, a sixth gain processing unit 750, and the first phase adjustment unit 780. The sixth synthesizing unit 795 synthesizes the input right signal component and left signal component, and applies the synthesized signal to the right headphone, thereby outputting the signal.

In the current embodiment, the fifth synthesizing unit 785 receives the inputs of the left signal component which is delayed and gain-adjusted, and the right signal component which is delayed and gain- and phase-adjusted, synthesizes the input signal components, and then, by applying the synthesized signal to the left headphone, outputs the signal. However, the present invention is not limited to this embodiment. That is, the left signal component which is delayed and gain-adjusted and the left signal component which is delayed and gain- and phase-adjusted may be input and synthesized, and then, the synthesized signal may be applied to the left headphone, thereby outputting the signal. According to the current embodiment, the delay processing units 700, 710, 720, and 730, the gain processing units 740, 750, 760, and 770, and the phase adjustment units 780 and 790 are to express reflection sounds, and the structure, including the number and arrangements, can vary with respect to a space in which the listener is positioned.

FIG. 8 is a detailed diagram illustrating a structure of the late reverberation sound processing unit 410 illustrated in FIG. 4 according to an embodiment of the present invention.

A process performed the late reverberation sound processing unit 410 illustrated in FIG. 4 will now be explained in detail with reference to FIG. 8.

The late reverberation sound processing unit 410 according to the current embodiment includes five all-pass filters 800, 810, 820, 830, and 840, which adjust gain values and delay values, thereby providing a reverberation effect.

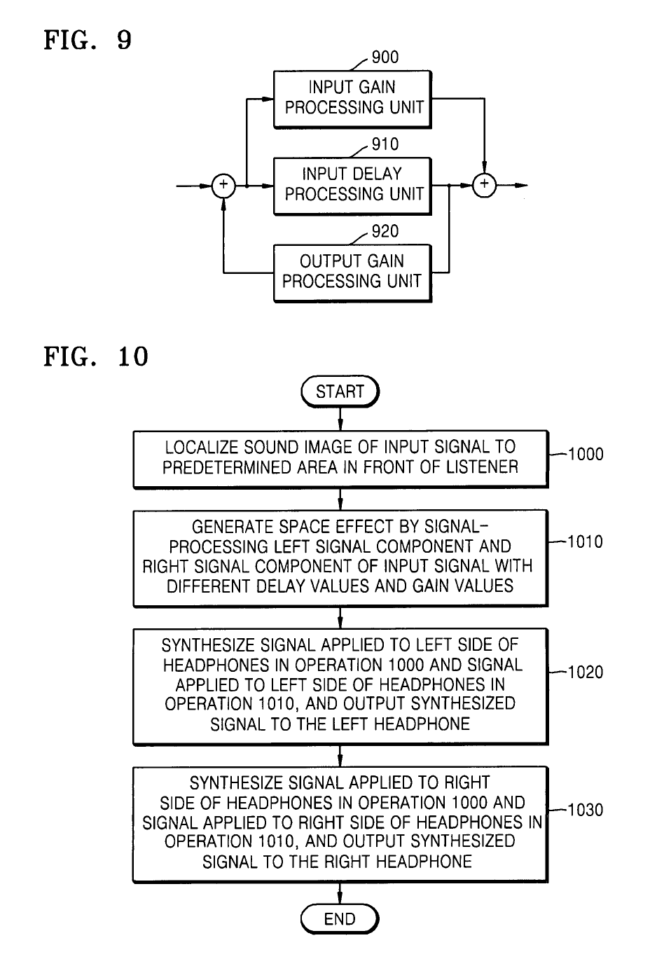

FIG. 9 is a diagram illustrating a structure of an all-pass filter illustrated in FIG. 8 according to an embodiment of the present invention. The all-pass filter illustrated in FIG. 8 according to the current embodiment includes an input gain processing unit 900, an input delay processing unit 910, and an output gain processing unit 920.

The input gain processing unit 900 adjusts the gain of an input signal and outputs the result to an output unit, and the input delay processing unit 910 delays the input signal and also outputs the result to the output unit. The output gain processing unit 920 adjusts the gain of the output signal, and again outputs to an input unit. In this process, the all-pass filter can adjust an attenuation coefficient without affecting an original sound.

When listening to a sound source in a large hall is compared with listening to a sound source in a forest, a phenomenon in which a reflection sound decreases appears in different ways. Thus, a late reverberation sound relates to the attenuation property of a reflection sound, and this attenuation is more influenced by the characteristic of a space in which the sound source is positioned, such as the shape of a space or the quality of materials, than by the size of the space. Since listening with headphones is not affected by external sounds, a late reverberation sound effect is not felt at all. Accordingly, the listener hears only a direct sound and reflection sound, and therefore the sound source provides a poor sound. In the current embodiment of the present invention, a reverberation effect is provided through the late reverberation sound processing unit 410 illustrated in FIG. 4. However, since a late reverberation sound effect provided through the late reverberation sound processing unit 410 may affect a reverberation effect included in a sound source, thereby changing the color of the sound, an appropriate attenuation coefficient should be set in order to prevent this sound color change. That is, the gain value and delay value of an all-pass filter is set to appropriate values in order to prevent sound color change, and through thus set gain value and delay value, the attenuation coefficient of the all-pass filter is adjusted.

Referring again to FIG. 4, the early reflection sound processing unit 400 illustrated in FIG. 4 processes an early reflection sound and outputs the result through the structure illustrated in FIG. 7, while the late reverberation sound processing unit 410 processes a late reverberation sound and outputs the result through the structure illustrated in FIG. 8.

Referring again to FIG. 1, the front recognition unit 100 illustrated in FIG. 1 localizes a sound image of an input signal input through the input terminal IN 1 to a virtual sound stage through the structure illustrated in FIG. 3, and outputs the result to the left and right channels of headphones, separately. Also, the space recognition unit 110 illustrated in FIG. 1 processes an early reflection sound and a late reverberation sound through the structure illustrated in FIG. 4, and outputs a signal to which a spatial effect is added, to the left and right channels of headphones, separately.

The first synthesizing unit 120 synthesizes the signal input from the front recognition unit 100 and the signal input from the space recognition unit 110, and applies the synthesized signal to the left headphone, thereby outputting the signal through the output terminal OUT 1.

The second synthesizing unit 130 synthesizes the signal input from the front recognition unit 100 and the signal input from the space recognition unit 110, and applies the synthesized signal to the right headphone, thereby outputting the signal through the output terminal OUT 2.

FIG. 10 is a flowchart illustrating a method of externalizing a sound image output from headphones according to an embodiment of the present invention.

In operation 1000, a sound image of an input signal is localized to a predetermined area in front of a listener. In this case, the input signal includes a left signal component and a right signal component, and the predetermined area in front of the listener means the virtual sound stage illustrated in FIG. 2.

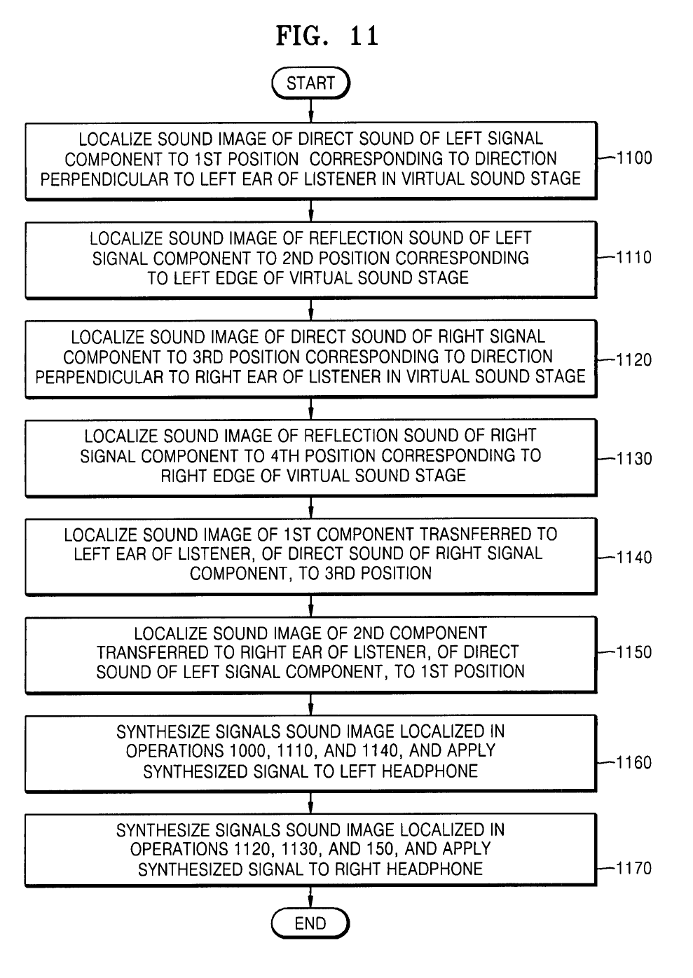

FIG. 11 is a flowchart illustrating a process of localizing a sound image of an input signal to a virtual sound stage in front of a listener according to an embodiment of the present invention.

A process performed in operation 1000 illustrated in FIG. 10 will now be explained in detail with reference to FIG. 11.

In operation 1100, a sound image of a direct sound of a left signal component is localized to a first position in a virtual sound stage, corresponding to a direction perpendicular to the left ear of a listener. More specifically, the left signal component is filtered by using a head related transfer function measured at the first position, and the sound image of the direct sound of the left signal component is localized to the first position. In this case, the first position corresponds to the first position 211 illustrated in FIG. 2.

In operation 1110, a sound image of a reflection sound of the left signal component is localized to a second position corresponding to the left edge of the virtual sound stage. More specifically, the left signal component is filtered by using a head related transfer function measured at the second position, then, the gain of the signal is adjusted, and the sound image of the reflection sound of the left signal component is localized to the second position. In this case, the second position corresponds to the second position 212 illustrated in FIG. 2.

In operation 1120, a sound image of a direct sound of the right signal component is localized to a third position corresponding to a direction perpendicular to the right ear of the listener. More specifically, the right signal component is filtered by using a head related transfer function measured at the third position, and the sound image of the direct sound of the right signal component is localized to the third position. In this case, the third position corresponds to the third position 213 illustrated in FIG. 2.

In operation 1130, a sound image of a reflection sound of the right signal component is localized to a fourth position corresponding to the right edge of the virtual sound stage. More specifically, the right signal component is filtered by using a head related transfer function measured at the fourth position, then, the gain of the signal is adjusted, and the sound image of the reflection sound of the right signal component is localized to the fourth position. In this case, the fourth position corresponds to the fourth position 214 illustrated in FIG. 2.

In operation 1140, a sound image of a first component transferred to the left ear of the listener in the right signal component is localized to the third position. More specifically, the right signal component is filtered by using a head related transfer function measured at the third position, then, the signal is delayed and gain-adjusted, and the sound image of the first component is localized to the third position.

In operation 1150, a sound image of a second component transferred to the right ear of the listener in the right signal component is localized to the third position. More specifically, the left signal component is filtered by using a head related transfer function measured at the first position, then, the signal is delayed and gain-adjusted, and the sound image of the second component is localized to the first position.

In operation 1160, all the signals whose sound images are localized in operations 1000, 1110, and 1140, are synthesized, and the synthesized signal is applied to the left headphone.

In operation 1170, all the signals whose sound images are localized in operations 1120, 1130, and 1150, are synthesized, and the synthesized signal is applied to the right headphone.

Referring again to FIG. 10, in operation 1010, the left signal component and the right signal component of the input signal are signal-processed with different delay values and gain values, thereby generating a spatial effect. That is, the delay values for delaying and the gain values for adjusting the gains of the left signal component and the right signal component are set to be different from each other. Thus, by signal-processing the left signal and the right signal with different delay values and gain values, a dissymmetric effect to reflection sounds is provided.

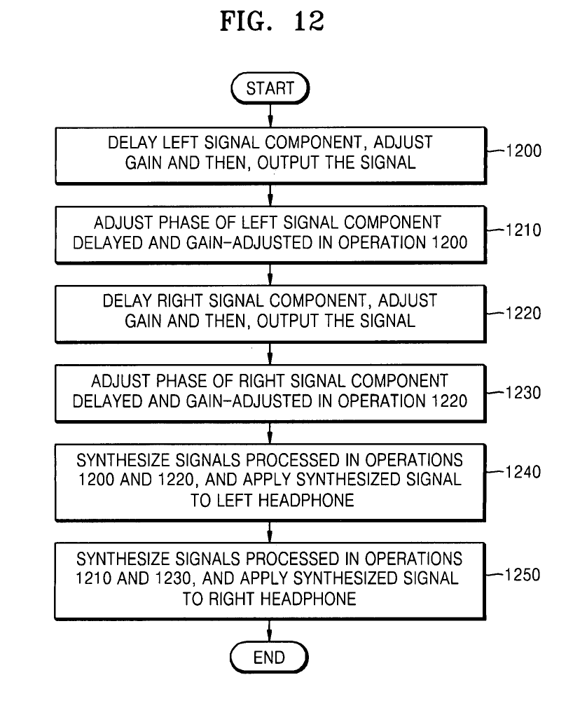

FIG. 12 is a detailed diagram of a process of providing a space effect to a listener according to an embodiment of the present invention.

A process performed in operation 1010 illustrated in FIG. 10 will now be explained in detail with reference to FIG. 12.

In operation 1200, the left signal component is delayed, and gain-adjusted, and the result is output.

In operation 1210, the phase of the left signal component which is delayed and gain-adjusted in operation 1200 is adjusted. Since it is not easy to provide a dissymmetric effect to the low frequency component of a reflection sound through delay and gain adjustment, the dissymmetric effect is provided by adjusting the phase.

In operation 1220, the right signal component is delayed, and gain-adjusted, and the result is output. In this case, the delay value for the delaying and the gain-adjusted value are different from those used in relation to the left signal in operation 1200.

In operation 1230, the phase of the right signal component which is delayed and gain-adjusted in operation 1220 is adjusted. Since it is not easy to provide a dissymmetric effect to the low frequency component of a reflection sound through delay and gain adjustment, the dissymmetric effect is provided by adjusting the phase.

In operation 1240, the signal processed in operations 1200 and 1220 are synthesized and the synthesized signal is applied to the left headphone. In the current embodiment, the left signal component which is delayed and gain-adjusted, and the right signal component which is delayed and gain- and phase-adjusted are input and synthesized, and then, the synthesized signal is applied to the left headphone, but the present invention is not limited to this. That is, a left signal component which is delayed and gain-adjusted, and a left signal component which is delayed and gain- and phase-adjusted may be input and synthesized, and then, the synthesized signal may be applied to the left headphone.

In operation 1250, the signal processed in operations 1210 and 1230 are synthesized and the synthesized signal is applied to the right headphone. In the current embodiment, the right signal component which is delayed and gain-adjusted, and the left right signal component which is delayed and gain- and phase-adjusted are input and synthesized, and then, the synthesized signal is applied to the left headphone, but the present invention is not limited to this. That is, a right signal component which is delayed and gain-adjusted, and a right signal component which is delayed and gain- and phase-adjusted may be input and synthesized, and then, the synthesized signal may be applied to the left headphone.

Referring again to FIG. 10, in operation 1020, the signal applied to the left headphone in operation 1000 and the signal applied to the left headphone in operation 1010 are synthesized, and the synthesized signal is output to the left headphone.

In operation 1030, the signal applied to the right headphone in operation 1000 and the signal applied to the right headphone in operation 1010 are synthesized, and the synthesized signal is output to the left headphone.

According to the apparatus and method of externalizing a sound image output from headphones according to the present invention as described above, a sound image of an input signal is localized to a predetermined area in front of a listener, and the left signal component and the right signal component of the input signal are signal-processed by using different delay values and gain values. In this way, the sound image output to the headphones can be localized to a virtual sound stage in front of the listener, thereby reducing tiredness occurring when listening through headphones, and even when a sound source includes many monophonic component, the sound image can be externalized.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMS, magnetic tapes, floppy disks, optical data storage devices, and carrier waves (such as data transmission through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for externalizing a sound image output from headphones, comprising:
a front recognition unit localizing the sound image of an input signal to a predetermined area in front of a listener; and
a space recognition unit signal-processing a left signal component and a right signal component of the input signal with different delay values and gain values, respectively.

2. The apparatus of claim 1, wherein the front recognition unit comprises:
a first sound image localization unit localizing a sound image of the left signal component to a first area corresponding to the left area of the predetermined area; and
a second sound image localization unit localizing a sound image of the right signal component to a second area corresponding to the right area of the predetermined area.

3. The apparatus of claim 2, wherein the first sound image localization unit comprises:
a first processing unit localizing a sound image of a direct sound of the left signal component to a first position corresponding to a direction perpendicular to the left ear of the listener in the first area; and
a second processing unit localizing a sound image of a reflection sound of the left signal component to a second position corresponding to the left edge of the first area, and
the second sound image localization unit comprises:
a third processing unit localizing a sound image of a direct sound of the right signal component to a third position corresponding to a direction perpendicular to the right ear of the listener in the second area; and
a fourth processing unit localizing a sound image of a reflection sound of the right signal component to a fourth position corresponding to the right edge of the first area.

4. The apparatus of claim 3, wherein the first processing unit comprises a first filter set by using a head related transfer function measured at the first position, and filters the left signal component with the first filter, thereby localizing the sound image of the direct sound of the left signal to the first position, and
the second processing unit comprises:
a second filter set by using a head related transfer function measured at the second position; and
a first gain processing unit adjusting a gain with a first gain value,
and the second processing unit filters the left signal component with the second filter, then, adjusts the gain through the first gain processing unit, and localizes the sound image of the reflection sound of the left signal to the second position, and
the third processing unit comprises a third filter set by using a head related transfer function measured at the third position and filters the right signal component with the third filter, thereby localizing the sound image of the direct sound of the right signal to the third position, and
the fourth processing unit comprises:
a fourth filter set by using a head related transfer function measured at the fourth position; and
a second gain processing unit adjusting a gain with a second gain value,
and the fourth processing unit filters the right signal component with the fourth filter, then, adjusts the gain through the second gain processing unit, and localizes the sound image of the reflection sound of the right signal to the fourth position.

5. The apparatus of claim 2, wherein the front recognition unit comprises:
a first post-processing unit localizing a sound image of a first component transferred to the left ear of the listener in the direct sound of the right signal component, to the third position; and
a second post-processing unit localizing a sound image of a second component transferred to the right ear of the listener in the direct sound of the left signal component, to the first position.

6. The apparatus of claim 5, wherein
the first post-processing unit comprises:
a first delay processing unit delaying the first component filtered through the third filter set by using the head related transfer function measured at the third position; and
a third gain processing unit adjusting a gain with a third gain value, and
the first post-processing unit adjusts the gain of the signal delayed through the first delay processing unit, through the third gain processing unit, and localizes the sound image of the first component to the third position, and
the second post-processing unit comprises:
a second delay processing unit delaying the second component filtered through the first filter set by using the head related transfer function measured at the first position; and
a fourth gain processing unit adjusting a gain with a fourth gain value, and
the second post-processing unit adjusts the gain of the signal delayed through the second delay processing unit, through the fourth gain processing unit, and localizes the sound image of the second component to the first position.

7. The apparatus of claim 6, further comprising:
a first synthesizing unit synthesizing all the signals whose sound images are localized through the first sound image localization unit and the first post-processing unit;
a first low-pass filter low-pass filtering a signal;
a second synthesizing unit synthesizing all the signals whose sound images are localized through the second sound image localization unit and the second post-processing unit; and
a second low-pass filter low-pass filtering a signal,
wherein the first low-pass filter filters a first signal synthesized in the first synthesizing unit, and outputs the filtered signal by applying the filtered signal to the left headphone, and
the second low-pass filter filters a second signal synthesized in the second synthesizing unit, and outputs the filtered signal by applying the filtered signal to the right headphone.

8. The apparatus of claim 1, wherein the space recognition unit comprises:
a third delay processing unit delaying the left signal component;
a fifth gain processing unit adjusting the gain of the left signal component delayed through the third delay processing unit, with a fifth gain value;
a fourth delay processing unit delaying the right signal component;
a sixth gain processing unit adjusting the gain of the right signal component delayed through the fourth delay processing unit, with a sixth gain value;
a first phase adjustment unit adjusting the phase of the left signal component gain-adjusted through the fifth gain processing unit; and
a second phage adjustment unit adjusting the phase of the right signal component gain-adjusted through the sixth gain processing unit.

9. The apparatus of claim 8, further comprising:
a third synthesizing unit applying the left signal component gain-adjusted through the fifth gain processing unit and the left signal component phase-adjusted through the first phase adjustment unit, to the left headphone, thereby outputting the signal; and
a fourth synthesizing unit applying the right signal component gain-adjusted through the sixth gain processing unit and the right signal component phase-adjusted through the second phase processing unit, to the right headphone, thereby outputting the signal.

10. The apparatus of claim 8, further comprising:
a fifth synthesizing unit applying the left signal component gain-adjusted through the fifth gain processing unit and the right signal component phase-adjusted through the second phase adjustment unit, to the left headphone, thereby outputting the signal; and
a sixth synthesizing unit applying the right signal component gain-adjusted through the sixth gain processing unit and the left signal component phase-adjusted through the first phase adjustment unit, to the right headphone, thereby outputting the signal.

11. A method of externalizing a sound image output to headphones comprising:
localizing the sound image of an input signal to a predetermined area in front of a listener; and
signal-processing a left signal component and a right signal component of the input signal with different delay values and gain values, respectively.

12. The method of claim 11, wherein the localizing of the sound image comprises:
localizing a sound image of the left signal component to a first area corresponding to the left area of the predetermined area; and
localizing a sound image of the right signal component to a second area corresponding to the right area of the predetermined area.

13. The method of claim 12, wherein the localizing of the sound image of the left signal component comprises:
localizing a sound image of a direct sound of the left signal component to a first position corresponding to a direction perpendicular to the left ear of the listener in the first area; and
localizing a sound image of a reflection sound of the left signal component to a second position corresponding to the left edge of the first area, and
the localizing of the sound image of the right signal component comprises:
localizing a sound image of a direct sound of the right signal component to a third position corresponding to a direction perpendicular to the right ear of the listener in the second area; and
localizing a sound image of a reflection sound of the right signal component to a fourth position corresponding to the right edge of the first area.

14. The method of claim 13, wherein in the localizing of the sound image of the direct sound of the left signal component to the first position, the sound image of the direct sound of the left signal component is localized to the first position by filtering the left signal component with a first filter set by using a head related transfer function measured at the first position, and
in the localizing of the sound image of the reflection sound of the left signal component to the second position, the sound image of the reflection sound of the left signal component is localized to the second position by filtering the left signal component with a second filter set by using a head related transfer function measured at the second position, and adjusting the gain, and
in the localizing the sound image of the direct sound of the right signal component to the third position, the sound image of the direct sound of the right signal component is localized to the third position by filtering the right signal component with a third filter set by using a head related transfer function measured at the third position, and
in the localizing of the sound image of the reflection sound of the right signal component to the fourth position, the sound image of the reflection sound of the right signal component is localized to the fourth position, by filtering the right signal component with a fourth filter set by using a head related transfer function measured at the fourth position, and adjusting the gain.

15. The method of claim 12, wherein the localizing of the sound image of the input signal to the predetermined area in front of the listener further comprises:
localizing a sound image of a first component transferred to the left ear of the listener in the direct sound of the right signal component, to a third position corresponding to a direction perpendicular to the right ear of the listener in the second area; and
localizing a sound image of a second component transferred to the right ear of the listener in the direct sound of the left signal component, to a first position corresponding to a direction perpendicular to the left ear of the listener in the first area.

16. The method of claim 15, wherein in the localizing of the sound image of the first component, the right signal component is filtered with a third filter set by using a head related transfer function measured at the third position, delayed, and gain-adjusted, thereby localizing the sound image of the first component to the third position, and
in the localizing of the sound image of the second component, the left signal component is filtered with a first filter set by using a head related transfer function measured at the first position, delayed and gain-adjusted, thereby localizing the sound image of the second component to the first position.

17. The method of claim 16, wherein the left signal component whose sound image is localized to the first area, and the first component whose sound image is localized to the third position are synthesized, and the synthesized signal is filtered with a low-pass filter, and output, by applying the filtered signal to the left headphone, and
the right signal component whose sound image is localized to the second area, and the second component whose sound image is localized to the first position are synthesized, and the synthesized signal is filtered with a low-pass filter, and output, by applying the filtered signal to the right headphone.

18. The method of claim 13, wherein the first position is identical to the third position.

19. The method of claim 11, wherein the signal-processing of the left signal component and right signal component of the input signal with different delay values and gain values, respectively, further comprises:
delaying the left signal component with a first delay value, and then, adjusting the gain with a first gain value; and
delaying the right signal component with a second delay value, and then, adjusting the gain with a second gain value, and
the delaying of the left signal component with the first delay value, and then, adjusting of the gain with the first gain value further comprises adjusting the phase of the left signal component gain-adjusted with the first gain value, and
the delaying of the right signal component with the second delay value, and then, adjusting of the gain with the second gain value further comprises adjusting the phase of the right signal component gain-adjusted with the second gain value.

20. The method of claim 19, wherein the delaying of the left signal component with the first delay value, and then, adjusting of the gain with the first gain value further comprises applying the phase-adjusted left signal component to the left headphone, thereby outputting the signal, and
the delaying of the right signal component with the second delay value, and then, adjusting of the gain with the second gain value further comprises applying the phase-adjusted right signal component to the right headphone, thereby outputting the signal.

21. The method of claim 19, wherein the delaying of the left signal component with the first delay value, and then, adjusting of the gain with the first gain value further comprises applying the phase-adjusted right signal component to the left headphone, thereby outputting the signal, and
the delaying of the right signal component with the second delay value, and then, adjusting of the gain with the second gain value further comprises
applying the phase-adjusted left signal component to the right headphone, thereby outputting the signal.

22. A computer readable recording medium having embodied thereon a computer program for executing the method of claim 11.
